(19) United States
(12) Patent Application Publication
(10) Pub. No.: US 2023/0101577 A1
(43) Pub. Date: Mar. 30, 2023

(54) MILLIMETER WAVE ANTENNA MODULE AND ELECTRONIC DEVICE

(71) Applicant: GUANGDONG OPPO MOBILE TELECOMMUNICATIONS CORP, LTD., Dongguan (CN)

(72) Inventor: Zhengdong Yong, Dongguan (CN)

(21) Appl. No.: 18/075,993

(22) Filed: Dec. 6, 2022

Related U.S. Application Data
(63) Continuation of application No. PCT/CN2021/089601, filed on Apr. 25, 2021.

(30) Foreign Application Priority Data
Jun. 8, 2020 (CN) 2020105131245

(51) Int. Cl. H01Q 9/04; H01Q 1/48; H01Q 21/06; H01Q 1/24

(52) U.S. Cl. CPC H01Q 9/0457; H01Q 1/48; H01Q 21/065; H01Q 1/243

(57) ABSTRACT

A millimeter wave antenna module includes a dielectric substrate, a ground plate, a radiation patch, a feeding structure, and a conductor structure. The dielectric substrate has a first side, on which the ground plate is disposed, and a second side, on which the radiation patch is disposed. The feeding structure is disposed between the radiation patch and the ground plate and penetrates the dielectric substrate and the ground plate. The conductor structure is disposed in the dielectric substrate. The conductor structure is spaced apart from the radiation patch and perpendicularly connected to the ground plate. The feeding structure is configured to feed the radiation patch to enable a first current to be generated on a surface of the radiation patch. Through couple-feeding between the conductor structure and the radiation patch, a second current perpendicular to a plane where the radiation patch is located can be excited and generated.

### CROSS-REFERENCE TO RELATED APPLICATIONS

This application is a continuation of International Application No. PCT/CN2021/089601, filed on Apr. 25, 2021, which claims priority to Chinese Patent Application No. 202010513124.5, titled “MILLIMETER WAVE ANTENNA MODULE AND ELECTRONIC DEVICE”, filed on Jun. 8, 2020 to the China National Intellectual Property Administration. The disclosures of the aforementioned applications are hereby incorporated by reference in their entireties.

### FIELD

The present disclosure relates to the technical field of antennas, and more particularly, to a millimeter wave antenna module and an electronic device.

### BACKGROUND

The statements here only provide background information related to the application, and do not necessarily constitute exemplary technologies.

5^{th}-generation (5G) network technology emerges with the development of wireless communication technology. 5G network, as the fifth generation of mobile communication network, has a theoretical peak transmission speed of tens of gigabits (Gb) per second, which is hundreds of times faster than that of 4^{th}-generation (4G) network. Therefore, the millimeter wave frequency band with sufficient spectrum resources has become one of the working frequency bands of the 5G communication system.

### SUMMARY

According to embodiments of the present disclosure, a millimeter wave antenna module and an electronic device are provided.

The millimeter wave antenna module includes a dielectric substrate, a ground plate, a radiation patch, a feeding structure, and a conductor structure. The dielectric substrate has a first side and a second side that are opposite to each other. The ground plate is disposed on the first side of the dielectric substrate. The radiation patch is disposed on the second side of the dielectric substrate. The feeding structure is disposed between the radiation patch and the ground plate. The feeding structure penetrates through the dielectric substrate and the ground plate. The feeding structure is configured to feed the radiation patch to enable a first current to be generated on a surface of the radiation patch. The conductor structure is disposed in the dielectric substrate. The conductor structure is spaced apart from the radiation patch and perpendicularly connected to the ground plate. The conductor structure is configured to, through couple-feeding with the radiation patch, excite and generate a second current perpendicular to a plane where the radiation patch is located.

The electronic device includes a housing, and the above-mentioned millimeter wave antenna module. The millimeter wave antenna module is received in the housing.

Details of one or more embodiments of the present disclosure are set forth in the following drawings and description. Other features, purposes, and advantages of the present disclosure will become apparent from the description, drawings, and claims.

### BRIEF DESCRIPTION OF THE DRAWINGS

In order to clearly explain technical solutions of embodiments of the present disclosure, drawings to be used in description of embodiments are briefly described below. The drawings described below are merely some embodiments of the present disclosure. Based on these drawings, other drawings can be obtained by those skilled in the art without creative effort.

FIG. 1 is a perspective view of an electronic device according to an embodiment.

FIG. 2 is a schematic structural diagram of a millimeter wave antenna module according to an embodiment.

FIG. 3 is a schematic structural diagram of a plurality of radiation patches according to an embodiment.

FIG. 4 is a schematic structural diagram of a slot of a radiation patch according to an embodiment.

FIG. 5 is a schematic diagram illustrating a partial structure of a millimeter wave antenna module according to an embodiment.

FIG. 6 is a schematic structural diagram of a millimeter wave antenna module according to an embodiment.

FIG. 7 is a schematic structural diagram of a millimeter wave antenna module according to an embodiment.

FIG. 8 is a schematic structural diagram of a conductor structure according to an embodiment.

FIG. 9 is a schematic structural diagram of a conductor structure according to an embodiment.

FIG. 10 is a schematic structural diagram of a conductor structure according to an embodiment.

FIG. 11 is a schematic structural diagram of a conductor structure according to an embodiment.

FIG. 12 is a schematic structural diagram of a positional relationship between a radiation patch and a conductor structure according to an embodiment.

FIG. 13 is a schematic structural diagram of a positional relationship between a radiation patch and a conductor structure according to an embodiment.

FIG. 14 is a schematic structural diagram of a positional relationship between a radiation patch and a conductor structure according to an embodiment.

FIG. 15 is a schematic structural diagram of a positional relationship between a radiation patch and a conductor structure according to an embodiment.

FIG. 16 is a schematic diagram illustrating a partial structure of a millimeter wave antenna module according to an embodiment.

FIG. 17 is an E-plane directional view of a millimeter wave antenna module according to an embodiment.

FIG. 18 is an H-plane directional view of a millimeter wave antenna module according to an embodiment.

FIG. 19 is an E-plane directional view of a conventional millimeter wave antenna module;

FIG. 20 is an H-plane directional view of a conventional millimeter wave antenna module;

FIG. 21 is a reflection parameter curve and an isolation curve of a millimeter wave antenna module according to an embodiment.

FIG. 22 is a partial diagram of a surface current distribution of a millimeter wave antenna module according to an embodiment.

FIG. 23 is a far-field pattern of a millimeter wave antenna module according to an embodiment. and

FIG. 24 is a front view of a housing assembly of an electronic device illustrated in FIG. 1 according to another embodiment.

### DETAILED DESCRIPTION

In order to clearly explain the objects, technical solutions and advantages of the present disclosure, the present disclosure is described in detail below with reference to accompanying drawings and embodiments. It should be understood that, the specific embodiments described herein are merely intended to illustrate, rather than limit, the present disclosure.

It will be understood that, the terms “first”, “second”, etc. may be used to describe various elements herein, but these elements are not limited by these terms. These terms are used only to distinguish a first element from another element and cannot be understood to indicate or imply relative importance or to imply the number of technical features indicated. Thus, the feature defined with “first” or “second” may include one or more this feature. In the present disclosure, “a plurality of” means at least two, for example, two or three, unless specified otherwise.

It should be noted that, when an element is described to be “disposed” on another element, it can be directly on the other element or there can also be an intermediate element. When an element is described to be “connected” to another element, it may be directly connected to the other element or may be connected to the other element via an intermediate element.

The millimeter wave antenna module according to an embodiment of the present disclosure is applied to an electronic device. In an embodiment, the electronic device may be a communication module, including a mobile phone, a tablet computer, a notebook computer, a palmtop computer, a Mobile Internet Device (MID), a wearable device (such as a smart watch, a smart bracelet, a pedometer, etc.), or other communication modules provided with the millimeter wave antenna module.

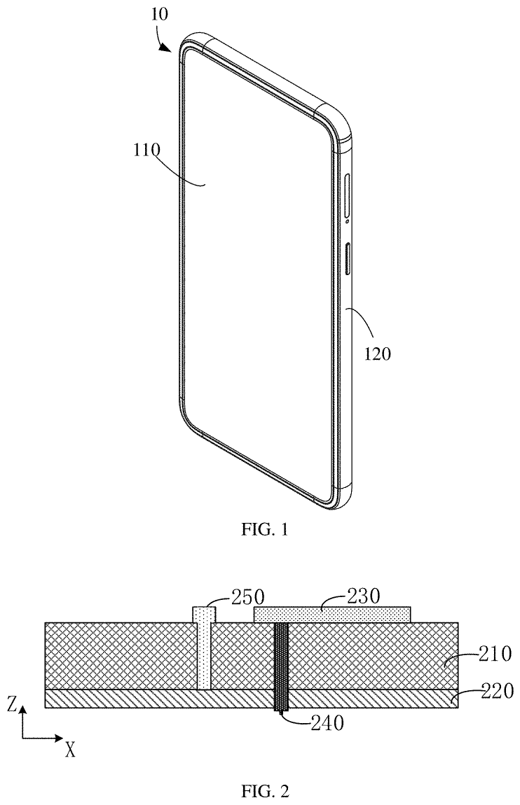

In an embodiment of the present disclosure, as illustrated in FIG. 1, the electronic device 10 may include a display assembly 110, a housing assembly 120, and a controller. The display assembly 110 is fixed on the housing assembly 120 and forms an external structure of the electronic device together with the housing assembly 120. The housing assembly 120 may include a middle frame and a rear cover. The middle frame may be a frame structure with through holes. The middle frame may be received in an accommodating space defined by the display assembly and the rear cover. The rear cover is configured to define an external contour of the electronic device. The rear cover may be formed as one piece. In a forming process of the rear cover, a rear camera hole, a fingerprint identification module, a mounting hole for the millimeter wave antenna module, and other structures may be formed on the rear cover. The rear cover may be a nonmetallic rear cover. For example, the rear cover may be a plastic rear cover, a ceramic rear cover, a 3D glass rear cover, etc. The controller can control the operation of the electronic device. The display assembly may be configured to display pictures or fonts, and may provide an operation interface for users.

In an embodiment, a millimeter wave antenna module is integrated in the housing assembly 120, and the millimeter wave antenna module can transmit and receive millimeter wave signals through the housing assembly 120, thereby enabling the electronic device to achieve a wide coverage of millimeter wave signals.

Millimeter wave refers to an electromagnetic wave with wavelength on the order of millimeters, and its frequency is approximately between 20 GHz and 300 GHz. The Third Generation Partnership Project (3GPP) has designated a list of frequency bands supported by 5G New Radio (5G NR), and the spectrum range of 5G NR may reach 100 GHz. It has specified two frequency ranges: Frequency range 1 (FR1), which is the frequency band below 6 GHz, and Frequency range 2 (FR2), which is the millimeter wave frequency band. Frequency range 1 ranges from 450 MHz to 6.0 GHz, of which the maximum channel bandwidth is 100 MHz. Frequency range 2 ranges from 24.25 GHz to 52.6 GHz, of which the maximum channel bandwidth is 400 MHz. The near 11 GHz spectrum for 5G mobile broadband includes: 3.85 GHz licensed spectrum, for example: 28 GHz (24.25 GHz to 29.5 GHz), 37 GHz (37.0 GHz to 38.6 GHz), 39 GHz (38.6 GHz to 40 GHz); and 14 GHz unlicensed spectrum (57 GHz to 71 GHz). The working frequency band of 5G communication system has three frequency bands: 28 GHz, 39 GHz, and 60 GHz.

As illustrated in FIG. 2, an embodiment of the present disclosure provides a millimeter wave antenna module. The millimeter wave antenna module includes a dielectric substrate 210, a ground plate 220, a radiation patch 230, a feeding structure 240, and a conductor structure 250. As an example, in FIG. 2, an end of the conductor structure 250 facing away from the ground plate 220 is coplanar with the radiation patch 230.

In the present embodiment, the dielectric substrate 210 has a first side and a second side that are opposite to each other. The ground plate 220 may be provided on the first side, and the radiation patch 230 may be provided on the second side.

In an embodiment, the millimeter wave antenna module may be a multilayer printed circuit board (PCB) integrated by High Density Interconnection (HDI) process or integrated circuit (IC) carrier board process. For example, the dielectric substrate 210 may include dielectric layers superimposed on each other, such as Prepreg (PP) layers, and each of the PP layers of the dielectric substrate 210 may be plated with a metal layer or a transmission strip line. The PP layer can have the functions of isolation and adhesion. The metal layer may be a copper layer, a tin layer, a lead-tin alloy layer, a tin-copper alloy layer, and the like. In an embodiment, the dielectric substrate 210 may employ a PP layer with a lower dielectric constant, which is beneficial to an increase in antenna bandwidth.

In the present embodiment, the ground plate 220 is disposed on the first side of the dielectric substrate 210, and a radio-frequency chip may be disposed on a side of the ground plate 220 facing away from the dielectric substrate 210. The ground plate 220 is a metal layer, such as a copper layer.

In the present embodiment, the radiation patch 230 is disposed on the second side of the dielectric substrate 210. The radiation patch 230 may be configured to transmit and receive millimeter wave signals. The radiation patch 230 may be a phased antenna array for radiating millimeter wave signals. The specific type of the antenna array is not further limited in the embodiments of the present disclosure, as long as the antenna array can transmit and receive millimeter wave signals.

In an embodiment, the radiation patch 230 includes a first feeding port and a second feeding port. The millimeter wave antenna module may include a plurality of radiation patches 230 arranged in an array. The first feeding ports of the plurality of radiation patches are mirror-symmetric in a direction of the array, and the second feeding ports of the plurality of radiation patches are mirror-symmetric in the direction of the array. In this way, the isolation between the feeding ports of adjacent radiation patches 230 can be improved, and mutual coupling between the radiation patches 230 can be reduced.

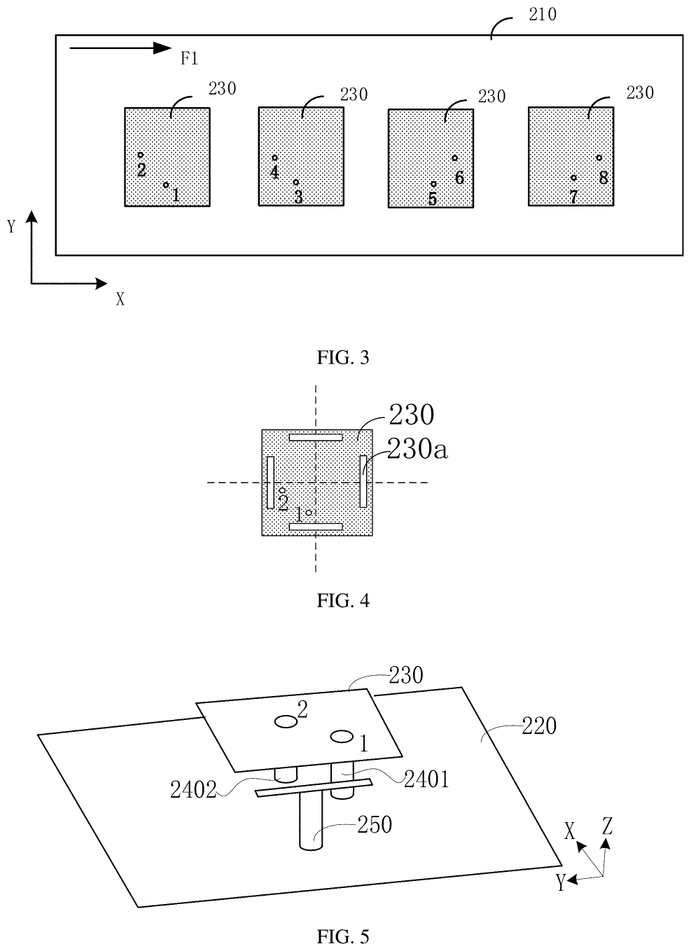

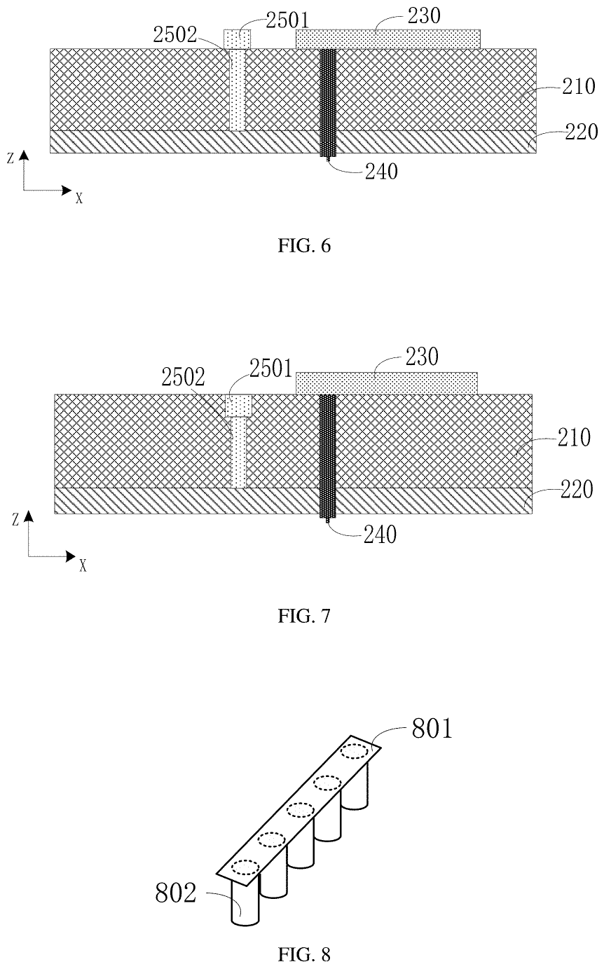

As an example, referring to FIG. 3, four radiation patches are arranged in a 1×4 linear rectangular arrangement, and a direction of the array is a single direction F1. The feeding ports are named as feeding port 1, feeding port 2, feeding port 3, feeding port 4, feeding port 5, feeding port 6, feeding port 7 and feeding port 8, respectively. The feed port 1 and the feed port 7 are mirror-symmetric. The feed port 2 and the feed port 8 are mirror-symmetric. The feed port 3 and the feed port 5 are mirror-symmetric. The feed port 4 and the feed port 6 are mirror-symmetric. By adopting a mirror symmetry, a spacing between the feeding port 4 and the feeding port 6, as well as a spacing between the feeding port 2 and the feeding port 8 can be both increased, thereby further improving the isolation between the feeding ports.

The number of radiation patches 230 and the spacing between every two adjacent radiation patches 230 can be determined based on specific scanning angles and gain requirements, which are not limited in the present embodiment.

In an embodiment, the radiation patch 230 can also adjust antenna matching by slotting or grooving. The slot or slit provided on the radiation patch 230 is beneficial to reduce a weight of the radiation patch 230 and adjust the impedance matching. In addition, the current path on the radiation patch 230 can be prolonged around the slot or slit, and thus the size of the radiation patch can be effectively reduced. At the same time, inductors and capacitors are additionally provided to effectively adjust the resonance characteristics of the radiation patch 230 and to broaden the bandwidth. For example, a slot provided on the radiation patch 230 may be a rectangular slot, a square slot, a U-shaped slot, an annular slot, or an oval slot, and the specific shape and position are set as desired. As an example, the slot may be provided as a rectangular slot, as illustrated in FIG. 4 (where 1 and 2 represent the feeding ports of the radiation patch 230), and four rectangular slots 230a are defined on the radiation patch 230. The four rectangular slots 230a are evenly distributed in intervals and at 90° around the axis of the radiation patch 230. In this way, the bandwidth can also be broadened by reducing the weight of the radiation patch 230 and adjusting impedance matching.

The shape of the radiation patch 230 is not limited herein. By way of example, the shape of the radiation patch 230 may be square or rectangular, or it may also be any other possible shapes, such as triangular, trapezoidal, or elliptical. For example, the radiation patch 230 is square with a side length ranging from 0.4λ to 0.5λ, where λ represents the wavelength of the electromagnetic wave in a medium at a center frequency.

The material of the radiation patch 230 may be a conductive material, such as a metal material, an alloy material, a conductive silica gel material, a graphite material, an indium tin oxide (ITO), or the like, or it may also be a material having a high dielectric constant, such as glass, plastic, ceramics or the like.

In the present embodiment, the feeding structure 240 is disposed between the radiation patch 230 and the ground plate 220, and the feeding structure 240 penetrates the dielectric substrate 210 and the ground plate 220. The feeding structure 240 is configured to feed the radiation patch 230 to enable a surface of the radiation patch 230 to generate a first current. As an example, the feeding structure 240 connects the feeding port of the radiation patch 230 with a radio-frequency port of the radio-frequency chip, and feeds the radiation patch 230 by inputting the radio frequency signal of the radio-frequency chip.

In an embodiment, a through hole may be formed on the dielectric substrate 210 and the ground plate 220 at a position corresponding to the position of the feeding ports of the radiation patch 230 and the position of the radio-frequency ports of the radio-frequency chip. The feeding structure 240 is formed by filing the through hole with a conductive material. The radio-frequency chip and the radiation patch 230 are in conduction via the feeding structure 240.

In an embodiment, as illustrated in FIG. 5 (FIG. 5 only illustrates the radiation patch 230, the ground plate 220, the feeding structure, and the conductor structure 250 in detail), the feeding structure includes a first feeding unit 2401 and a second feeding unit 2402. The first feeding unit 2401 is disposed between the first feeding port 1 of the radiation patch 230 and the first radio-frequency port of the radio-frequency chip. The first feeding unit 2401 is configured to input a first radio frequency signal and feed the first feeding port 1. The second feeding unit 2402 is disposed between the second feeding port 2 of the radiation patch 230 and the second radio-frequency port of the radio-frequency chip. The second feeding unit 2402 is configured to input a second radio frequency signal and feed the second feeding port 2. The radio-frequency chip is connected to the radiation patch 230 through the first feeding unit 2401 and the second feeding unit 2402 to feed a current signal into the radiation patch 230.

In the present embodiment, the conductor structure 250 is disposed in the dielectric substrate 210 (the conductor structure 250 may be disposed within the dielectric substrate 210 or may be partially exposed outside the dielectric substrate 210), and the conductor structure 250 is spaced apart from the radiation patch 230 and perpendicularly connected to the ground plate 220. The conductor structure 250 is configured to, through couple-feeding with the radiation patch 230, excite and generate a second current perpendicular to the plane where the radiation patch is located. The plane where the radiation patch is located may correspond to a surface of the radiation pitch facing away from the ground plate 220.

As an example, while the radiation patch 230 obtains the first current by means of the feeding structure 240 and the radio-frequency chip, a capacitive coupling between the conductor structure 250 and the radiation patch 230 can be realized due to the presence of a spacing between the conductor structure 250 and the radiation patch 230. Thus, the millimeter wave antenna module can have a smaller size. At the same time, due to the capacitive coupling, the conductor structure 250 can excite and generate the second current perpendicular to the plane where the radiation patch is located, and the second current can interact with the first current on the surface of the radiation patch 230 to change the electric field of the entire millimeter wave antenna module and broaden the beamwidth of the millimeter wave antenna module. Meanwhile, the conductor structure 250 suppresses a monopole mode of the feeding structure 240 and strengthens a differential mode of the radiation patch 230, thereby suppressing a cross-polarized component and increasing the isolation of the dual-polarized ports. When the spacing between the conductor structure 250 and the radiation patch 230 is smaller, the capacitive coupling is stronger, and the operating frequency of the millimeter wave antenna module shifts toward a lower frequency. Thus, the millimeter wave antenna module with a smaller size can be obtained. The spacing is not limited herein, and the spacing can be sufficiently small but never be zero.

In an embodiment, the conductor structure is also configured to, through couple-feeding with the radiation patch 230, excite and generate a third current parallel to the plane where the radiation patch 230 is located. Therefore, the third current, the first current, and the second current further interact with each other, thereby improving the feeding coupling efficiency and further broadening the beamwidth of the millimeter wave antenna module.

In an embodiment, the conductor structure 250 includes a vertical conductor 2502 and a horizontal conductor 2501 that are connected to each other.

The vertical conductor 2502 is connected to the ground plate 220. The vertical conductor 2502 is configured to, through couple-feeding with the radiation patch 230, excite and generate the second current perpendicular to the plane where the radiation patch 230 is located. As an example, since the vertical conductor 2502 is spaced apart from the radiation patch 230, when the radiation patch 230 excites and generates the first current through the feeding structure 240, the capacitive coupling between the vertical conductor 2502 and the radiation patch 230 can be achieved by the vertical conductor 2502 to generate the second current perpendicular to the plane where the radiation patch 230 is located.

The horizontal conductor 2501 is disposed parallel to and spaced apart from the radiation patch 230 and perpendicularly connected to the vertical conductor 2502. The horizontal conductor 2501 is configured to, through couple-feeding with the radiation patch 230, excite and generate the third current parallel to the plane where the radiation patch 230 is located. As an example, since the horizontal conductor 2501 is arranged parallel to and spaced apart from the radiation patch 230, when the radiation patch 230 excites and generates the first current through the feeding structure 240, the capacitive coupling between the horizontal conductor 2501 and the radiation patch 230 can be achieved by the horizontal conductor 2501 to generate the third current parallel to the plane where the radiation patch 230 is located.

The horizontal conductor 2501 and the radiation patch 230 are arranged parallel to and spaced apart from each other in such a manner that the horizontal conductor 2501 and the radiation patch 230 are arranged in the same layer or in different layers. For example, a first plane where the horizontal conductor 2501 is located is coplanar with a second plane where the radiation patch 230 is located; or the first plane is below the second plane; or the first plane is above the second plane. The first plane is a surface of the horizontal conductor 2501 facing away from the ground plate 220, and the second plane correspond to a surface of the radiation patch 230 facing away from the ground plate 220. When the first plane where the horizontal conductor 2501 is located is coplanar with the second plane where the radiation patch 230 is located or when the first plane is located below the second plane, the radiation efficiency of the radiation patch 230 can be enhanced and the space size of the millimeter wave antenna module can be further reduced.

Further, when the first plane is located below or above the second plane, an orthographic projection of the horizontal conductor 2501 on the second plane partially overlaps the radiation patch 230, or the orthographic projection of the horizontal conductor 2501 on the second plane is spaced apart from the radiation patch 230 (as the example illustrated in FIG. 7).

In an embodiment, the horizontal conductor includes a metal sheet parallel to and spaced apart from the radiation patch 230. The vertical conductor includes a metal pillar perpendicular to the ground plate 220. The metal pillar is connected to both the metal sheet and the ground plate 220. Thus, the couple-feeding between conductor structure 250 and the radiation patch 230 can be achieved through the metal sheet and the metal pillar, to generate the third current and the second current, thereby affecting the electric field distribution of the entire millimeter wave antenna module. In other embodiments, the vertical conductor may be a metallized via defined in the dielectric substrate 210, and for example, the vertical conductor is formed by electroplating a layer of copper on the wall of the metallized via in the dielectric substrate 210.

The shape and area of the metal sheet are not specified, and they can be determined based on an area to be in contact with the metal pillar, the number of the metal pillars, and arrangement of the metal pillars.

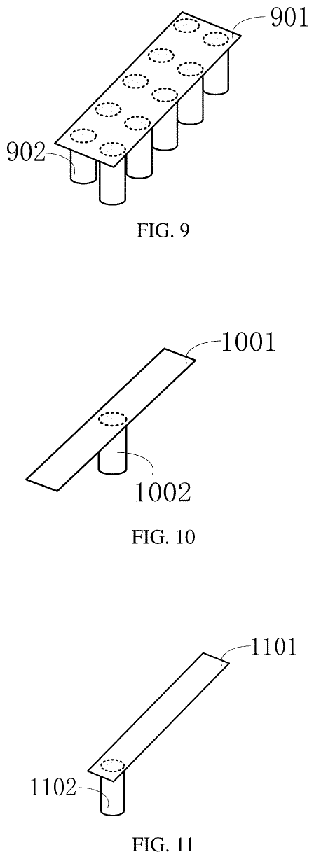

The number of vertical conductors may be one or more. When a plurality of metal pillars is provided, adjacent metal pillars are parallel to and spaced apart from each other. As an example, the plurality of metal pillars are arranged in a one-dimensional matrix or in a multi-dimensional matrix. The one-dimensional matrix can refer to FIG. 8. In FIG. 8, as an example, 5 metal pillars are provided, the metal sheet is denoted with 801, and the metal pillar is denoted with 802. The multi-dimensional matrix can refer to FIG. 9. In FIG. 9, as an example, 10 metal pillars are provided, the metal sheet is denoted with 901, and the metal pillar is denoted with 902.

The shape of the metal sheet and the metal pillar is not specified. For example, the shape of the conductor structure 250 may be a “T” shape (as illustrated in FIG. 10, in which the metal sheet is denoted with 1001 and the metal pillar is denoted with 1002), an inverted “L” shape (as illustrated in FIG. 11, in which the metal sheet is denoted with 1001 and the metal pillar is denoted with 1002) or a grid-like shape (as illustrated in FIG. 8 and FIG. 9).

In an embodiment, each radiation patch 230 may correspond to a plurality of conductor structures 250 arranged at equal heights. By providing the plurality of conductor structures 250 at equal heights, the distribution of the current field excited by the vertical conductors of each conductor structure 250 can be the same, and thus each conductor structure 250 has the same effect on broadening the beam.

Further, the plurality of conductor structures 250 are uniformly arranged around the corresponding radiation patch 230. By uniformly arranging the plurality of conductor structures 250 around the corresponding radiation patch 230, the electric field distribution around the radiation patch 230 can be uniform. In this way, the suppressed cross-polarized components of the antenna element, which is composed of the radiation patch 230 and the plurality of conductor structures 250 corresponding to the radiation patch 230, are the same everywhere. Therefore, the dual-polarization port isolation is higher, the capacitive loading is more uniform, and the sizes of the antenna elements can be balanced. The uniform arrangement may be in various forms, which are not specified herein and can be set according to the shape of the radiation patch 23.

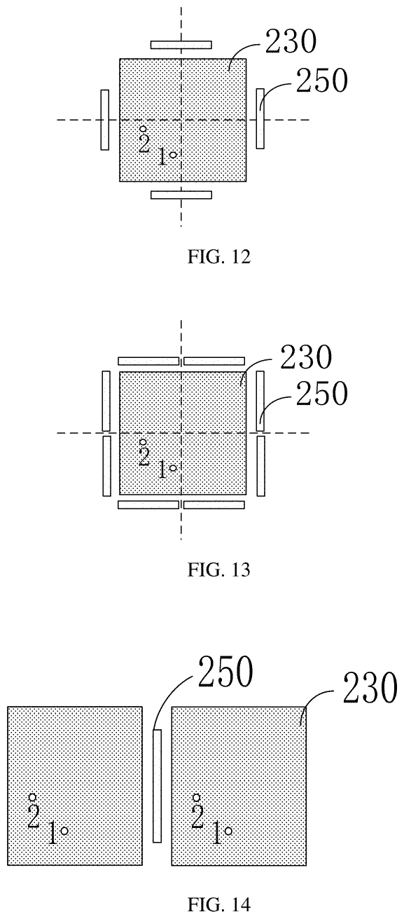

As an example, the radiation patch 230 has a square shape. The radiation patch 230 has two central axes perpendicular to each other. When the number of conductor structures 250 is four, the conductor structures 250 may be uniformly arranged in the way as illustrated in FIG. 12. FIG. 12 illustrates projections of the conductor structures 250 on the second plane. The orthographic projections of the four conductor structures 250 on the second plane are respectively located on and perpendicular to extension lines of the two central axes of the radiation patch 230, and the two parallel conductor structures 250 are symmetrical to each other. When the number of conductor structures 250 is eight, the conductor structures 250 may be uniformly arranged in the way illustrated in FIG. 13. FIG. 13 illustrates projections of the conductor structures 250 on the second plane. The orthographic projections of the eight conductor structures 250 on the second plane are located on the left and right sides of extension lines of the two central axes of the radiation patch 230 and are each perpendicular to the extension lines. Two parallel conductor structures 250 are symmetrical to each other, and two conductor structures 250 located on the same side of the radiation patch 230 are also symmetrical to each other.

In an embodiment, a plurality of radiation patches 230 may be provided, and at least one conductor structure 250 is disposed between every two adjacent radiation patches 230. In this way, the millimeter wave signals radiated by two adjacent radiation patch 230 can be prevented from influencing each other, the cross-polarized component caused by mutual coupling of the feeding structures 240 between the two adjacent radiation patches 230 can be effectively suppressed, and the isolation between the two adjacent radiation patches 230 can be further improved.

As an example, four radiation patches 230 are arranged in a one-dimensional array. As illustrated in FIG. 14, one conductor structure 250 is provided between two adjacent radiation patches 230. FIG. 14 illustrates an orthographic projection of the conductor structure 250 on the second plane. In this way, the isolation of ports between the two adjacent radiation patches 230 can be suppressed by the conductor structure 250.

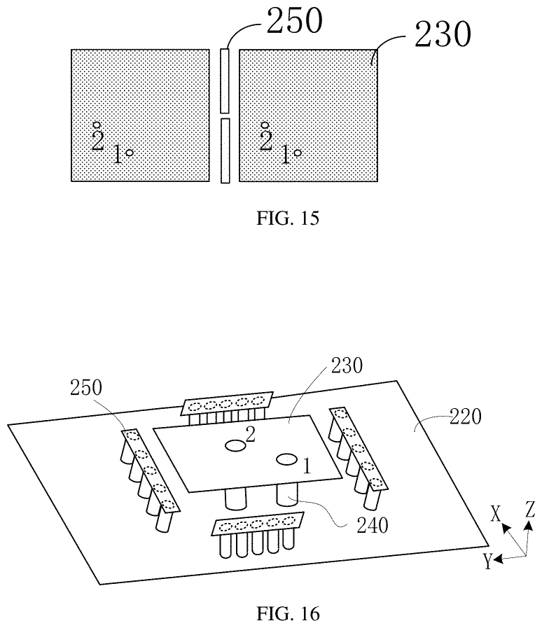

As an example, four radiation patches 230 are arranged in a one-dimensional array. As illustrated in FIG. 15, two conductor structures 250 are provided between two adjacent radiation patches 230. FIG. 15 illustrates projections of the conductor structures 250 on the second plane. In this way, the isolation of ports between the two adjacent radiation patches 230 can be suppressed by the conductor structures 250, while the electric field at which each radiation patch 230 is located is more uniform and the effect of cross-polarized component suppression is better.

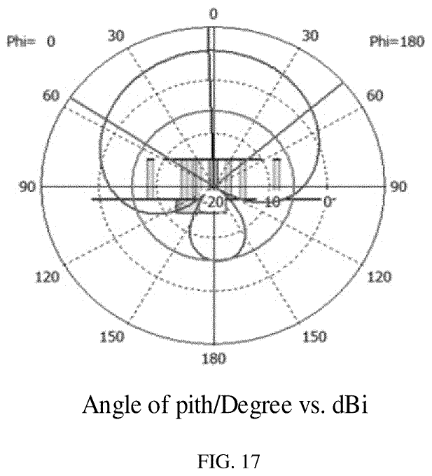

In the following embodiment, an exemplary millimeter wave antenna module according to the present disclosure and a conventional exemplary millimeter wave antenna module are compared, and the test results are as follows. The exemplary millimeter wave antenna module according to the present disclosure is, for example, illustrated in FIG. 16, in which one radiation patch 230 of the millimeter wave antenna module corresponds to four conductor structures 250, each vertical conductor includes five metal pillars, and the dielectric substrate is shown.

Size: the size of the exemplary millimeter wave antenna module according to the present disclosure is 1.95 mm×1.95 mm×0.85 mm, while the conventional exemplary millimeter wave antenna module is 2.45 mm×2.45 mm×0.85 mm. The size of the millimeter wave antenna module according to the present disclosure is reduced by 20%.

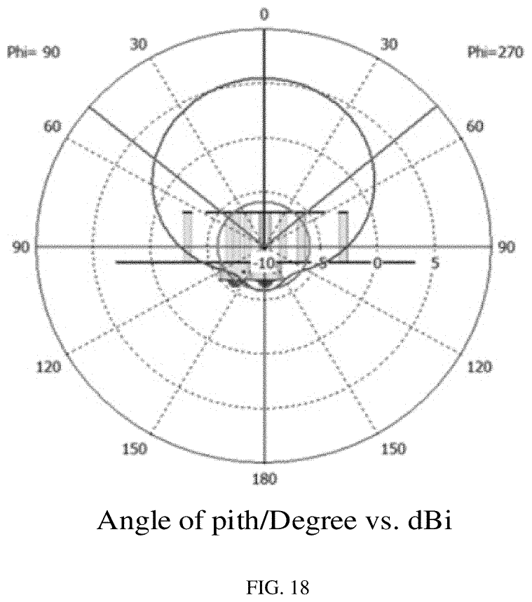

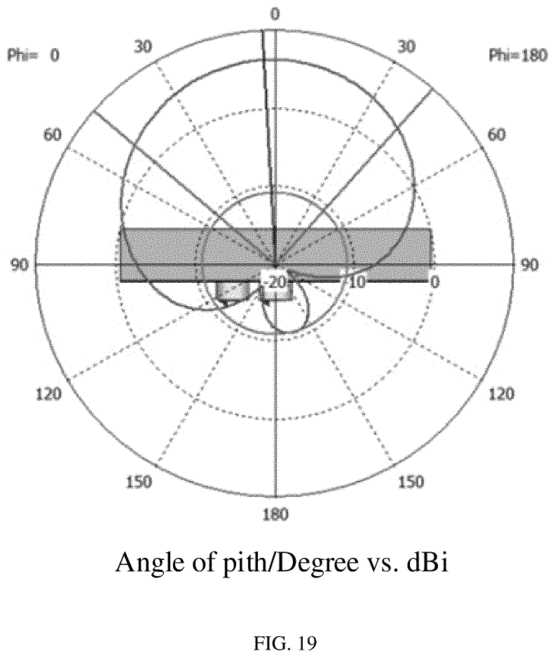

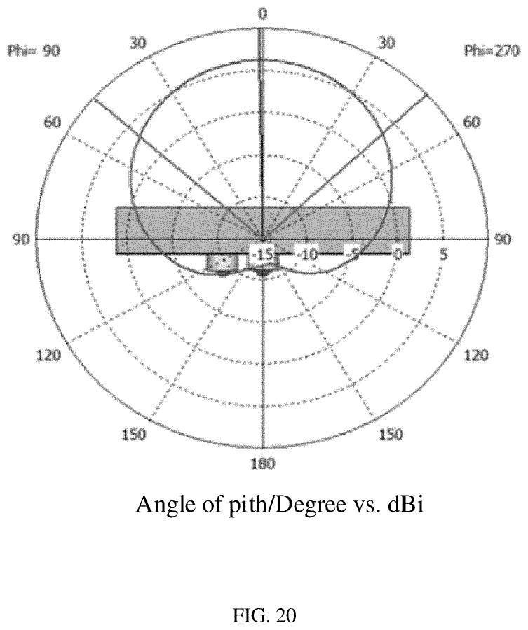

Beamwidth can refer to FIG. 17 to FIG. 20. FIG. 17 and FIG. 18 are E-plane and H-plane directional views of the exemplary millimeter wave antenna module according to the present disclosure operating at 28 GHz, respectively, illustrating the beam radiation of the exemplary millimeter wave antenna module according to the present disclosure. In FIG. 17, a main lobe size is 5.45 dBi, a main lobe direction is 2.0 deg, a side lobe level is −11.2 dB, and an E-plane half-power beamwidth is 105.3 deg. In FIG. 18, a main lobe size is 5.45 dBi, a main lobe direction is 0.0 deg, a side lobe level is −11.3 dB, and an H-plane half-power beamwidth is 99.5 deg. FIG. 19 and FIG. 20 are E-plane and H-plane directional views of the conventional exemplary millimeter wave antenna module operating at 28 GHz, respectively, illustrating the beam radiation of the conventional exemplary millimeter wave antenna module. In FIG. 19, a main lobe size is 6.2 dBi, a main lobe direction is 3.0 deg, a side lobe level is −17.1 dB, and an E-plane half-power beamwidth is 90.5 deg. In FIG. 20, a main lobe size is 6.2 dB, a main lobe direction is 1.0 deg, and an H-plane half-power beamwidth is 94.9 deg. Referring to FIG. 17 to FIG. 20, the exemplary millimeter wave antenna module according to the present disclosure has a wider beamwidth than the conventional exemplary millimeter wave antenna module.

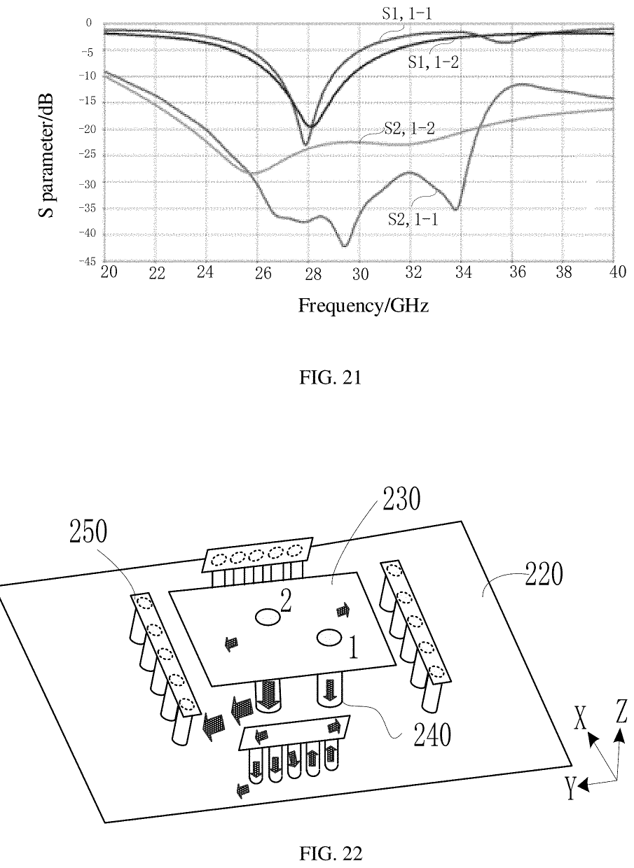

Isolation of dual-polarized ports can refer to FIG. 21. In FIG. 21, curve S1, 1-1 corresponds to a reflection coefficient curve of a feeding port 1 of the exemplary millimeter wave antenna module according to the present disclosure; curve S2, 1-1 corresponds to an isolation curve between the feeding port 2 and the feeding port 1 of the exemplary millimeter wave antenna module according to the present disclosure; curve S1, 1-2 corresponds to a reflection coefficient curve of the conventional exemplary millimeter wave antenna module; and curve S2, 1-2 corresponds to an isolation curve between the feeding port 2 and the feeding port 1 of the conventional exemplary millimeter wave antenna module. As revealed in FIG. 21, when operating at 28 GHz, a reflection coefficient of the feeding port 1 of the exemplary millimeter wave antenna module according to the present disclosure is −23 dB, while a reflection coefficient of the feeding port 1 of the conventional exemplary millimeter wave antenna module is −19 dB; an isolation between feeding ports of the exemplary millimeter wave antenna module according to the present disclosure is smaller than −28 dB in the operating frequency band ranging from 26 GHz to 34 GHz, while an isolation between feeding ports of the conventional exemplary millimeter wave antenna module is greater than −28 dB in the operating frequency band ranging from 26 GHz to 34 GHz. Therefore, the exemplary millimeter wave antenna module according to the present disclosure has higher dual polarization port isolation than the conventional exemplary millimeter wave antenna module.

Analysis is conducted in conjunction with the test results described above.

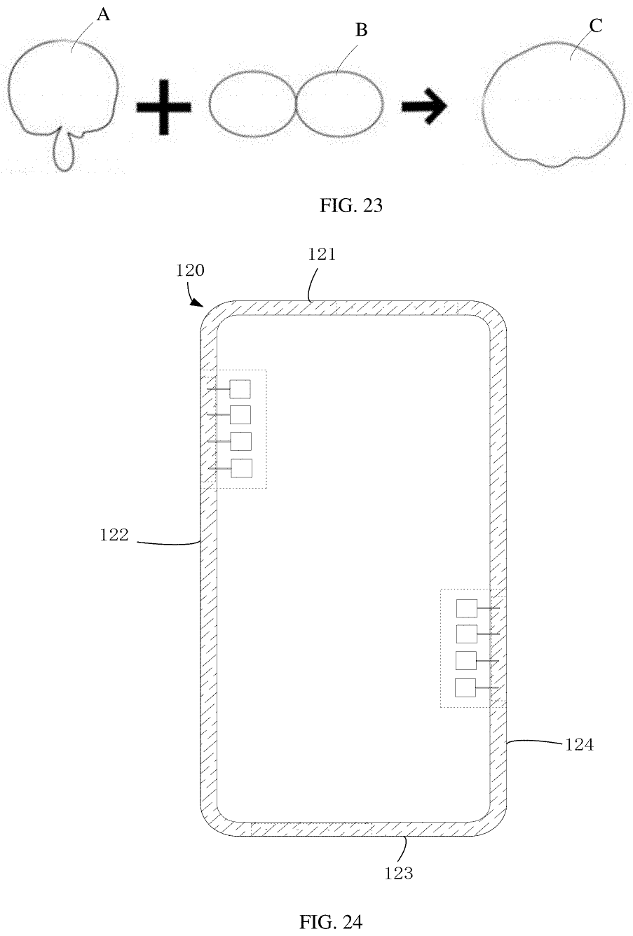

The exemplary millimeter wave antenna module according to the present disclosure has a smaller size by means of a capacitively loaded conductor structure 250. At the same time, the conductor structure 250 can excite and generate the second current and the third current through couple-feeding with the radiation patch 230. The second current and the third current, together with the first current on the surface of the radiation patch 230, can change the electric field distribution of the module, allowing the module to have a wider beamwidth. FIG. 22 is a partial diagram of a surface current distribution of an exemplary millimeter wave antenna module in the 28 GHz frequency band. In FIG. 22, the filled arrows represent current flow directions, of which a thicker arrow represents a greater current intensity, and a thinner arrow represents a smaller current intensity. As illustrated in FIG. 22, the radiation patch 230 excites a surface current on an x-y plane. In the conductor structure 250, the horizontal conductor and the vertical conductor excite the surface current along the x-y plane and the surface current along a z-axis direction, respectively. As illustrated in FIG. 23, a far-field pattern of the surface current of the radiation patch 230 is shown as A, and a far-field pattern of the surface current of the vertical conductor is shown as B, and a far-field pattern with a wider beamwidth as indicated by C is obtained through a superposition of A and B. In this way, the module has a wider beamwidth. Furthermore, by introducing the conductor structure 250, a monopole mode of the feeding structure 240 is suppressed, the electric field is confined in a cavity, and the differential mode of the radiation patch 230 is strengthened, thereby suppressing the cross-polarized component and enhancing the isolation of the dual-polarization port.

The above-mentioned millimeter wave antenna module includes the dielectric substrate 210, the ground plate 220, the radiation patch 230, the feeding structure 240, and the conductor structure 250. The radiation patch 230 is fed through the feeding structure 240 to generate a first current on the surface of the radiation patch 230, while the coupling feed between the conductor structure 250 and the radiation patch 230 excites and generates a second current perpendicular to the plane where the radiation patch 230 is located. By introducing the capacitive loaded conductor structure 250, the millimeter wave antenna module can have a smaller size, realizing thinning of the antenna module. In addition, due to the first current and the second current, the electric field distribution of the module can be changed, and thus the module can have a wider beamwidth. Meanwhile, the monopole mode of the feeding structure 240 is suppressed, and the differential mode of the radiation patch 230 is strengthened, thereby suppressing the cross-polarized component and enhancing the isolation of the dual polarization ports.

As illustrated in FIG. 24, an electronic device includes a housing and a millimeter wave antenna module according to any of the above embodiments. The millimeter wave antenna module is received in the housing.

In an embodiment, the electronic device includes a plurality of millimeter wave antenna modules. The plurality of millimeter wave antenna modules are distributed on different sides of the housing. For example, the housing has a first side 121, a second side edge 122, a third side edge 123 opposite to the first side edge 121, and a fourth side edge 124 opposite to the second side edge 122. The second side 122 is connected to an end of the first side 121 and an end of the third side 123. The fourth side 124 is connected to another end of the first side 121 and another end of the third side 123. The millimeter wave antenna modules are disposed on at least two of the first side edge 121, the second side edge 122, the third side edge 123, and the fourth side edge 124. When two millimeter wave antenna modules are provided, the two millimeter wave antenna modules are located on the second side 122 and the fourth side 124, respectively, to reduce the overall size of the millimeter wave antenna module in a dimension of a non-scanning direction. Therefore, it is possible to place the millimeter wave antenna modules on two sides of the electronic device.

The electronic device including the millimeter wave antenna module according to any one of the above embodiments can be used to receive and transmit millimeter wave signals in 5G communication, thereby effectively expanding the beamwidth and the isolation of dual-polarized ports. Thus, the radiation efficiency of antennas can be enhanced. Meanwhile, the size of the module is effectively reduced, realizing the thinning of antenna modules and reducing the space occupied by the antenna modules in electronic device.

The electronic device may be a mobile phone, a tablet computer, a notebook computer, a palmtop computer, a Mobile Internet Device (MID), a wearable device (such as a smart watch, a smart bracelet, a pedometer, etc.), or any other communication module provided with an antenna.

Any reference to memory, storage, databases, or other media used by embodiments of the present disclosure may include non-volatile and/or volatile memory. Suitable non-volatile memory may include Read-Only Memory (ROM), Programmable ROM (PROM), Electrically Programmable ROM (EPROM), Electrically Erasable Programmable ROM (EEPROM), or flash memory. The volatile memory may include Random Access Memory (RAM), which acts as external cache memory. By way of illustration and not limitation, RAM is available in a variety of forms such as Static RAM (SRAM), Dynamic RAM (DRAM), Synchronous DRAM (SDRAM), Double Data Rate SDRAM (DDR SDRAM), Enhanced SDRAM (ESDRAM), Synchronous Link (Synchlink) DRAM (SLDRAM), Rambus Direct RAM (RDRAM), Direct Rambus Dynamic RAM (DRDRAM), and Rambus Dynamic RAM (RDRAM).

The technical features in the foregoing embodiments can be arbitrarily combined with each other. However, for brevity, all possible combinations of the technical features in the foregoing embodiments, although not described one by one, shall be within the scope of the present disclosure, unless the technical features are contradictory to each other.

The above embodiments illustrate merely some implementations of the present disclosure, and they are described in detail. However, these embodiments shall not be construed to limit the scope of the present disclosure. Various changes and improvements made by those skilled in the art without departing from the principle of the present disclosure shall fall within the protection scope of the present disclosure. The protection scope of the present disclosure is determined by the appended claims.

What is claimed is:

1. A millimeter wave antenna module, comprising:
a dielectric substrate having a first side and a second side that are opposite to each other;
a ground plate disposed on the first side of the dielectric substrate;
a radiation patch disposed on the second side of the dielectric substrate;
a feeding structure disposed between the radiation patch and the ground plate, the feeding structure penetrating through the dielectric substrate and the ground plate, the feeding structure being configured to feed the radiation patch to enable a first current to be generated on a surface of the radiation patch; and
a conductor structure disposed in the dielectric substrate, the conductor structure being spaced apart from the radiation patch and perpendicularly connected to the ground plate, and the conductor structure being configured to, through couple-feeding with the radiation patch, excite and generate a second current perpendicular to a plane where the radiation patch is located.

2. The millimeter wave antenna module according to claim 1, wherein the conductor structure is further configured to, through couple-feeding with the radiation patch, excite and generate a third current parallel to the plane where the radiation patch is located.

3. The millimeter wave antenna module according to claim 2, wherein the conductor structure comprises:
a vertical conductor perpendicularly connected to the ground plate, the vertical conductor being configured to, through couple-feeding with the radiation patch, excite and generate the second current perpendicular to the plane where the radiation patch is located; and
a horizontal conductor parallel to and spaced apart from the radiation patch and perpendicularly connected to the vertical conductor, the horizontal conductor being configured to, through couple-feeding with the radiation patch, excite and generate the third current parallel to the plane where the radiation patch is located.

4. The millimeter wave antenna module according to claim 3, wherein a first plane where the horizontal conductor is located is coplanar with a second plane where the radiation patch is located.

5. The millimeter wave antenna module according to claim 3, wherein a first plane where the horizontal conductor is located below or above a second plane where the radiation patch is located.

6. The millimeter wave antenna module according to claim 5, wherein:
the first plane is located below the second plane; and
an orthographic projection of the horizontal conductor on the second plane partially overlaps the radiation patch.

7. The millimeter wave antenna module according to claim 5, wherein:
the first plane is located below the second plane; and
an orthographic projection of the horizontal conductor on the second plane is spaced apart from the radiation patch.

8. The millimeter wave antenna module according to claim 3, wherein:
the horizontal conductor comprises a metal sheet parallel to and spaced apart from the radiation patch; and
the vertical conductor comprises a metal pillar perpendicular to the ground plate, the metal pillar being connected to the metal sheet and the ground plate.

9. The millimeter wave antenna module according to claim 8, wherein:
the vertical conductor comprises a plurality of metal pillars; and
adjacent metal pillars of the plurality of metal pillars are parallel to and spaced apart from each other.

10. The millimeter wave antenna module according to claim 9, wherein the plurality of metal pillars are arranged in a one-dimensional matrix or in a multi-dimensional matrix.

11. The millimeter wave antenna module according to claim 1, wherein the closer the conductor structure is to the radiation patch, the more an operating frequency of the millimeter wave antenna module is shifted towards a lower frequency.

12. The millimeter wave antenna module according to claim 1, wherein:
the millimeter wave antenna module comprises a plurality of radiation patches; and
at least one conductor structure is disposed between every two adjacent radiation patches of the plurality of radiation patches.

13. The millimeter wave antenna module according to claim 12, wherein each of plurality of radiation patches corresponds to a plurality of conductor structures arranged at equal heights.

14. The millimeter wave antenna module according to claim 13, wherein the plurality of conductor structures are arranged uniformly around the radiation patch corresponding to the plurality of conductor structures.

15. The millimeter wave antenna module according to claim 1, wherein:
the millimeter wave antenna module comprises a plurality of radiation patches arranged in an array;
each of the plurality of radiation patches has a first feeding port and a second feeding port; and
the first feeding ports of the plurality of radiation patches are mirror-symmetric in a direction of the array, and second feeding ports of the plurality of radiation patches are mirror-symmetric in the direction of the array.

16. The millimeter wave antenna module according to claim 15, wherein a radio-frequency chip is disposed on a side of the ground plate facing away from the dielectric substrate, the radio-frequency chip having a first radio-frequency port and a second radio-frequency port, and
wherein the feeding structure comprises:
a first feeding unit disposed between the first feeding port and the first radio-frequency port, the first feeding unit being configured to input a first radio-frequency signal and feed the first feeding port; and
a second feeding unit disposed between the second feeding port and the second radio-frequency port, the second feeding unit being configured to input a second radio-frequency signal and feed the second feeding port.

17. The millimeter wave antenna module according to claim 1, wherein the radiation patch has a slot or slit configured to adjust impedance matching of the millimeter wave antenna module.

18. An electronic device, comprising:
a housing; and
a millimeter wave antenna module received in the housing,
wherein the millimeter wave antenna module comprises:
a dielectric substrate having a first side and a second side that are opposite to each other;
a ground plate disposed on the first side of the dielectric substrate;
a radiation patch disposed on the second side of the dielectric substrate;
a feeding structure disposed between the radiation patch and the ground plate, the feeding structure penetrating through the dielectric substrate and the ground plate, the feeding structure being configured to feed the radiation patch to enable a first current to be generated on a surface of the radiation patch; and
a conductor structure disposed in the dielectric substrate, the conductor structure being spaced apart from the radiation patch and perpendicularly connected to the ground plate, and the conductor structure being configured to, through couple-feeding with the radiation patch, excite and generate a second current perpendicular to a plane where the radiation patch is located.

19. The electronic device according to claim 18, comprising a plurality of millimeter wave antenna modules distributed on different sides of the housing.

20. The electronic device according to claim 19, wherein:
the housing has a first side edge, a second side edge, a third side edge opposite to the first side edge, and a fourth side edge opposite to the second side edge, the second side edge being connected to an end of the first side edge and an end of the third side edge, and the fourth side edge being connected to another end of the first side edge and another end of the third side edge; and
the plurality of millimeter wave antenna modules are disposed on at least two of the first side edge, the second side edge, the third side edge, and the fourth side edge.
